(19) United States
(12) Patent Application Publication
(10) Pub. No.: US 2011/0080986 A1
(43) Pub. Date: Apr. 7, 2011

(54) METHOD OF TRANSMUTING VERY LONG LIVED ISOTOPES

(76) Inventors: ROBERT E. SCHENTER, Portland, OR (US); Michael K. Korenko, Pasco, WA (US)

(21) Appl. No.: 12/508,536

(22) Filed: Oct. 5, 2009

(51) Int. Cl. G21G 1/00

(52) U.S. Cl. 376/202; 376/156

(57) ABSTRACT

At least one very long lived isotope, such as I-129, and a moderator, such as MgH₂, is ground, homogeneously mixed and contained in a target assembly which can be at least one target assembly capable of being accessed and vented. The homogeneous mixture is a target which is irradiated, preferrably by a fast reactor flux, thereby transmuting the at least one isotope to a stable or short lived isotope. Resulting gasses, short lived and stable isotopes have medical and industrial uses and value. The transmuted short lived or stable isotopes do not require long term storage.

### FIELD OF THE INVENTION

This invention relates to a method of transmuting very long lived isotopes into stable non-radioactive isotopes and short lived isotopes many of which are commercially valuable.

### BACKGROUND OF THE INVENTION

Cold war legacy waste materials at United States Department of Energy sites, including those at Hanford in Washington State, and spent nuclear power fuel, contains very long lived radioactive isotopes with half lives greater than one-hundred thousand (100,000) years.

The disposal of such materials has been viewed as a costly and problematic long term storage challenge. Long term storage has included consideration of storage at Yucca Mountain in Nevada.

This invention discloses a method of processing very long lived isotopes without the need for long term storage. This invention discloses a disposal method which is much less costly while fully minimizing long term storage concerns.

### SUMMARY OF THE INVENTION

This invention discloses the process of Transmutation of very long lived isotopes into stable or short lived isotopes not requiring long term storage. A moderator, from materials that are oxides or hydrides, and a radioactive isotope, are ground, homogeneously mixed and irradiated to transmute very long lived isotopes to short lived or stable isotopes. The harvesting of gasses, which may be produced during transmutation including Xe-129, Xe-130 and Xe-132, and isotopes having medical and industrial value is also disclosed and claimed.

### BRIEF DESCRIPTION OF THE FIGURES

FIG. 1 graphically presents the results of burnout calculations for Tc-99 and 1-129, for time periods up to 400 days.

FIG. 2 graphically demonstrates production rates of 1-131 for a 40 day irradiation.

FIGS. 3 and 4 demonstrates the production of Xe-130 and Xe-132.

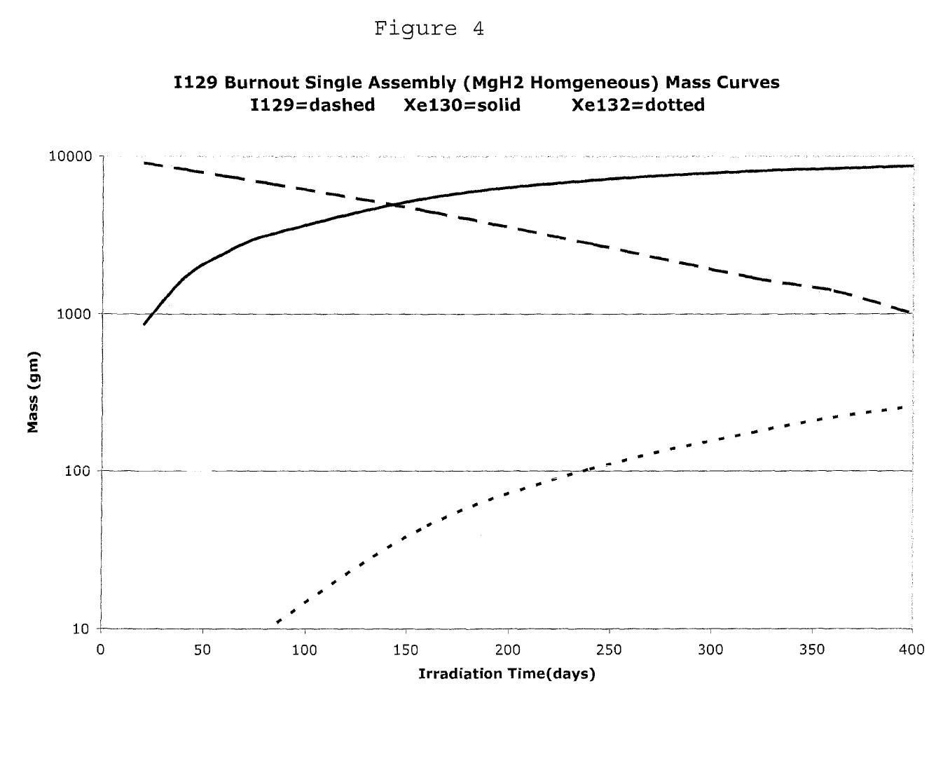

### DETAILED DESCRIPTION

The results of this process is exemplified by examination of two long lived fission products, Iodine-129 having a half life of 1.57×10⁷ years and Technetium-99, having a half life of 4.2×10⁶ years. We provide calculations and experimental results which shows that large quantities of these products, including Iodine-129, 1:=1.57×10⁷ years and Technetium-99, 1:=4.2×10⁶ years, can be essentially completely “burned out” in a large fast reactor. The result of this process is to transmute the original “target” material to either stable or short-lived isotopes not requiring very long term storage.

The elimination of very long term storage is but one benefit. For the two isotopes analyzed, a major additional benefit is that the transmuted products are valuable materials. Iodine-129 (I-129) produces the major therapeutic medical isotope Iodine-131 (I-131). Technetium-99 (Tc-99) transmutes to the stable “noble” metal Ruthenium-100 (Ru-100).

The efficiency of this method can be increased by “tailoring” the fast reactor neutron spectrum in the target assembly using moderating materials such as yttrium-hydride. Experimental results demonstrating the success of this approach were obtained in the Fast Flux Test Facility (FFTF) in the “Multiple Isotope Production” (MIP) test.[1]

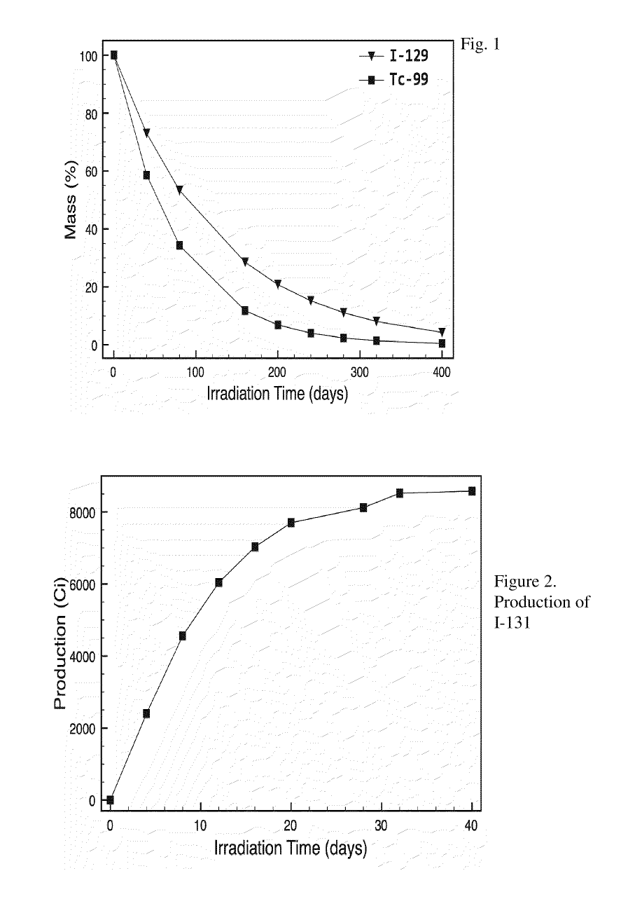

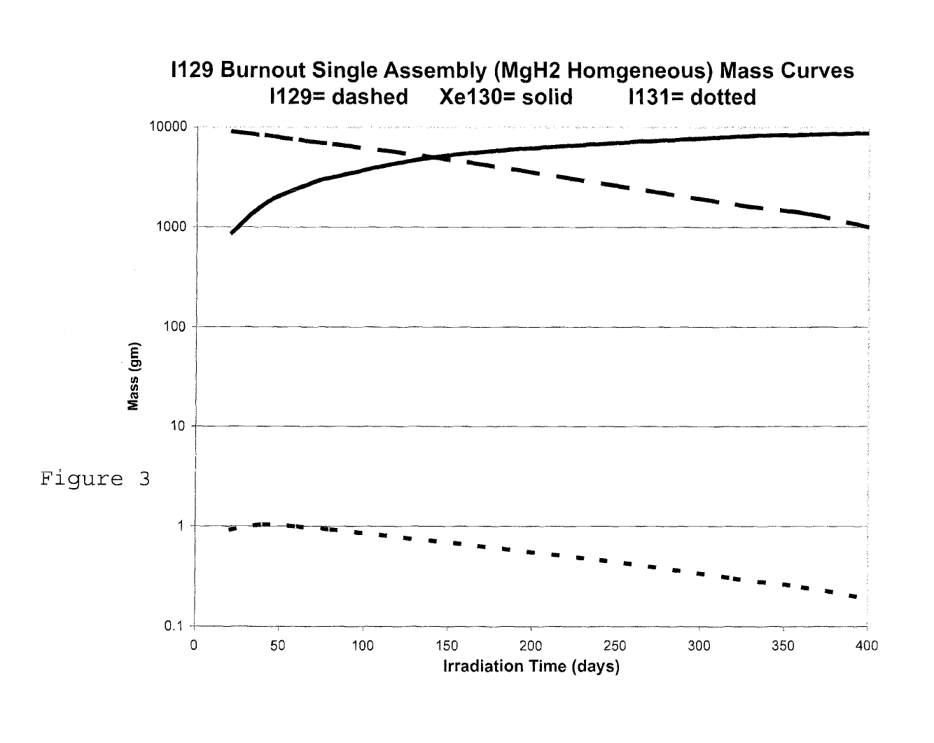

This disclosure presents curves of 1-129 and Tc-99 “burnout” with irradiation time and the production of I-131 for different irradiation periods. In this Summary FIG. 1 presents the results of burnout calculations for time periods up to 400 days. The calculation methods are identified in Reference [2]. For these results one “flux tailored” spectrum was used consistent with previous FFTF calculations and what is expected to be obtained after detailed flux tailoring analyses. Also production rates of 1-131 are given in FIG. 2 for a 40 day irradiation.

FIG. 2. illustrates production of I-131 from double capture from I-129 burnout in a large fast reactor system with a flux energy of 4.0×10¹⁵ neutrons per square centimeter per second.

Table I. presents a list of the very long life fission products, their fission yields and their half lives.

Calculations demonstrate that a single target assembly can transmute ten (10) kilograms of Tc-99 in a single year. Thus a single fast reactor can continually transmute the waste of several thermal reactors in an Energy Park. The actinides can be converted to fuel and the very long life radioisotopes converted to non radioactive, short lived or stable isotopes and or medical/industrial isotopes.

TABLE I
Very Long Lived Fission Products*

| | Half-Life | Fission |
|---|---|---|
| Isotope | (years) | Yield |
| Cadmium-113 | 9.0 × 10¹⁵ | 0.014 |
| Iodine-129 | 1.57 × 10⁷ | 0.54 |
| Palladium-107 | 6.5 × 10⁶ | 0.146 |
| Technetium-99 | 4.2 × 10⁶ | 6.1 |
| Cesium-135 | 2.3 × 10⁶ | 6.54 |
| Zirconium-93 | 1.5 × 10⁶ | 6.35 |
| Selenium-79 | 6.5 × 10⁵ | 0.045 |
| Tin-126 | 2.5 × 10⁵ | 0.059 |

*Half-Life greater than 10⁵ years

### FFTF MIP Test—Experimental Results

The Multiple Isotope Production (MIP) Test Assembly was irradiated in the FFTF during May 1989. Its main purpose was to reduce uncertainties in the production and burnout of key nuclear materials (Pu238, Pu236 and several “beneficial isotopes”). In addition the two very log lived fission products Tc-99 and I-129 were included in the test.

Reaction rate predictions for comparison with measurements were made using the Monte Carlo N-particle (MCNP) transport code.

A full-core, three dimensional FFTF model of the Cycle 11 A core was created, with each of the assemblies in the reactor modeled homogeneously except for the MIP assembly and the four surrounding GEM Assemblies. The GEM Assemblies and the MIP Assembly were modeled in detail as disclosed in Reference [1].

The test results showed good agreement of “burnout” for the Tc-99 and I-129 targets resulting in C/E values of 0.80 and 0.86 for Tc-99 and I-129, respectively.

### REFERENCES

[1]. D. W. Wootan et al., “Isotope Production Test in the Fast Flux Test Facility,” Proceedings, “LMR: A Decade of LMR Progress and Promise”, ANS Meeting, Washington, D.C. November II-IS, 1990.
[2]. R. E. Schenter, “Comparison of Medical Isotope Production in Fast and Thermal Reactor Systems,” “Proceedings, LMR: A Decade of LMR Progress and Promise,” ANS Meeting, Washington, D.C. Nov. 11-15, 1990.

The patents and other prior are referred to herein are provided herewith in an Information Disclosure Statement in accordance with 37 CFR 1.97.

### Results

Calculations and Experimental results show that large quantities of two important long lived fission products (Iodine-129, τ=1.57×10⁷ years and Technetium-99, τ=4.2×10⁶ years) can be essentially completely “burned out” in a large fast reactor. The result of this process is to transmute the original “target” material to either stable or short-lived isotopes not requiring very long term “storage.”

For the two isotopes analyzed, a major side benefit is that the transmuted products are valuable materials. Iodine-129 (I-129) produces the major therapeutic medical isotope Iodine-131 (I-131). Technetium-99 (Tc-99) transmutes to the stable “noble” metal Ruthenium-100 (Ru-100).

This method can be made especially efficient by “tailoring” the fast reactor neutron spectrum in the target assembly using slowing down materials comprising oxides or hydrides such as yttrium-hydride. Experimental results demonstrating the success of this approach were even obtained in the FFTF in the “Multiple Isotope Production” (MIP) test as seen in Reference [1].

Self shielding effects slow the desired reaction by factors often to one hundred. Several configurations were explored, such as rod, disks, and tubes; however, a homogeneous mix of moderator and isotope, comprising the target, was the most effective.

The ideal target assembly consists of vented containers of the target, a homogeneous mixture of the isotope and the moderator. The venting prevents any potential pressure build-up and allows the valuable gases to be collected in the reactor gas recovery system. These containers can be arranged in a single reactor assembly. Alternatively, a single larger container could be used. Containers can be cylinders. In the FFTF the containers were hex containers.

Transmutation of Iodine-129 can produce non-radioactive Xenon isotopes 129, 130, 131, which have a commercial value. Alternatively, I-129 could be transmuted to I-131, which is a valuable medical isotope. The practical transmutation for medical treatment must be recoverable on a periodic basis; therefore a “rabbit” devise that moved into the core region is required. A container containing a homogeneous mixture of Iodine-129 and the moderator would be inserted into the rabbit.

Grinding the very long lived isotope and the moderator into particles, including a very fine powder, with particles having generally consistent diameters in the range of 0.01 mm to 1.0 cm and with the preferred range of 0.01 mm to 1.0 mm, and homogeneously mixing the isotope and moderator particles overcomes the problem of self shielding which has been observed with disks and rods.

The Hanford defense waste is estimated to contain approximately 10 kg of Tc-99. Power Reactor spent fuel, in a reprocessing stream, will produce approximately 10 kg of Tc-99/year per thermal reactor. Very long storage of these quantities of Tc-99 require nominal space and will be relatively easy to manage.

In the field of nuclear engineering, a rabbit refers to a controlled tool used to insert and extract a container containing a target inside the core of a nuclear reactor. In the present application the target may be subject to irradiation other than from the core of a nuclear reactor. In the preferred embodiment the target will typically be contained in at least one container, identified in this application as a target assembly, and comprised generally of at least one container capable of being vented. The irradiation of certain isotopes may produce gasses and transmuted isotopes, capable of medical and industrial uses, which must be periodically extracted from the target assembly. Rabbits and such target assemblies, containers capable of being vented, are known to those of ordinary skill in nuclear science arts.

The method of Transmutation of Very Long Lived Isotopes described and claimed in this application includes the steps of a. selecting a moderator from the group consisting of materials that are hydrides or oxides; b. selecting a radioactive isotope from the group consisting of very long lived isotopes; c. grinding the moderator and the radioactive isotope to comprise particles; mixing the particles thereby reducing self shielding; the mixed particles forming a target; d. containing the target in a target assembly; e. irradiating the target thereby transmuting long lived isotopes to short lived or stable isotopes; f. containing gasses, if any, in the target assembly; harvesting gasses captured; g. harvesting transmuted isotopes having medical or industrial value, if any, for medical or industrial applications.

Additionally, the moderator can be selected from the group consisting of yttrium, calcium, beryllium and magnesium, the radioactive isotope can be selected from the group consisting of radioactive isotopes having a half-life of more than 10⁵ years and the irradiation of the target should be in the range of 0.01 ev-100 kev; the irradiation of the target assembly should be in the range of 100 ev-20 Mev. The preferred source of radiation, for greatest efficiency in burning out the isotopes of interest, is a fast reactor. The flux from a fast reactor, which can be tailored to the very long lived isotope being burned out, is many times more efficient than a flux from a thermal reactor. FFTF is but one fast reactor, which could be the flux source, with others in France and in Russia. There are also other reactor designs, including a Thorium concept, which can provide the flux energy required for the most efficient burn out.

In the preferred embodiment the irradiation is a fast reactor flux. The moderator is selected from the moderator is from the group of yttrium, calcium, beryllium and magnesium. In the preferred embodiment the moderator is from the group consisting of yttrium hydride, calcium hydride, beryllium hydride and magnesium hydride. Additionally, the radioactive isotope is selected from the group consisting of Cadmium-113, Iodine-129, Palladium-107, Technetium-99, Cesium-135, Zirconium-93, Selenium-79 and Tin-126 and the fast reactor flux energy is 100 ev-20 MeV.

The isotope and moderator are ground into particles sized in the range of 0.01 mm to 1.0 cm diameter. In the preferred embodiment the particles are ground into a fine powder in the range of 0.01 mm to 1.0 mm and the isotope and moderator are combined to a homogeneous mixture.

The target assembly consists of at least one container which contains the target of the mixed at least one isotope and moderator. The target assembly can contain gasses and can be vented to allow for harvesting of gases, if any, contained in the target assembly. Harvesting gases is accomplished with a reactor gas/isotope recovery system. Transmuted short lived isotopes, having medical or industrial uses and value, can also be harvested. the reactor gas/isotope recovery system will generally utilize a rabbit to periodically retrieve and reinsert the target assembly from and into the source of flux.

Gases available for harvesting include Xe-129, Xe-130 and or Xe-132 and I-131 when the very long lived isotope is I-129.

In the preferred embodiment, where the isotope is Iodine-129, τ=1.57×10⁷ years or Technetium-99, τ=4.2×10⁶ years, and the moderator is selected from the hydrides of Mg, this process will result in essentially complete “burning out” of said isotopes, in a large fast reactor, over a period of approximately 400 days. The process will transmute Iodine-129 (I-129) to the major therapeutic medical isotope Iodine-131 (I-131) or Xenon isotopes 129 and 130 and 131, which have a commercial value. The process will transmute Technetium-99 (Tc-99) to the stable “noble” metal Ruthenium-100 (Ru-100).

A summary of the process of this method of transmutation of very long lived radioactive isotopes comprises selecting a very long lived radioactive isotope from the group consisting of isotopes having a half life of at least 10⁵ years; selecting a moderator from the group consisting of hydrides or oxides; mixing particles of the moderator with particles of the isotope forming a target; and irradiating the target. Additionally, the long lived radioactive isotopes can be selected from the group consisting of Cadmium-113, Iodine-129, Palladium-107, Technetium-99, Cesium-135, Zirconium-93, Selenium-79, Tin-126; and the target can be contained in a target assembly. Gasses may be produced by the process with any gasses produced captured and contained in the target assembly which is capable of being vented and accessed for the harvesting of gasses and of short lived isotopes. A rabbit is utilized in the typical process of retrieving and reinserting of a target assembly from a irradiation flux.

Again, the process of burning out long lived isotopes is described and claimed as follows: selecting an isotope from the group consisting of very long lived isotopes including Iodine-129, τ=1.57×10⁷ years and Technetium-99, τ=4.2×10⁶ years); selecting a moderator from the group consisting of oxides or hydrides; homogeneously mixing the isotope and the moderator; the homogeneous mixture comprising a target; the isotope comprising an isotope desired to be transmuted to a stable or short-lived isotope not requiring very long term storage; irradiating the target; and containing the target in a target assembly. The target assembly will typically be capable of being vented and accessed for the harvesting gasses, if any, and or transmuted isotopes. Also there will be a homogeneous combining of the radioactive component, comprised of radioactive spent fuel or radioactive defense waste, with a moderator. The homogeneous mixture comprises a target. Irradiating the target with a flux transmutes at least a portion of said radioactive component, where a portion of the radioactive component is transmuted, the process will require a periodic separating of said the target into fractions including a nontransmuted fraction and a transmuted transuranic fraction and of reintroducing said nontransmuted fraction into said flux for further transmutation. Additionally, the process will assume capturing gasses, if any, which are produced by the process and disposing of the transmuted fraction into storage or for medical or industrial uses and disposing of the captured gasses for medical or industrial uses. The radioactive component may be selected from the group consisting of long lived or very long lived isotopes; the moderator may be selected from the group consisting of materials that form hydrides or oxides; with the flux energy in the range of 0.01 ev-100 keV and with the target in a target assembly. Where the radioactive component is I-129, producing I-131 from double neutron capture from I-129 burnout where the flux energy is in the range from 1.0×10¹⁴ neutrons per cm² per second to 1.0×10¹⁶ neutrons per cm² per second and more specifically where the flux energy is 4.0×10¹⁵ neutrons per square centimeter per second. In the preferred embodiment the flux is produced in a fast reactor.

I claim:

1. A Method of Transmutation of Long Lived Isotopes comprising:
a. selecting a moderator from the group consisting of materials that are hydrides or oxides;
b. selecting at least one radioactive isotope from the group consisting of very long lived isotopes;
c. grinding the moderator and the radioactive isotope to comprise particles; mixing the particles thereby reducing self shielding; the mixed particles forming a target;
d. containing the target in a target assembly;
e. irradiating the target assembly and target thereby transmuting the at least one long lived isotopes to short lived isotopes;
f. containing gasses and transmuted isotopes in the target assembly.

2. The method of claim 1 further comprising:
a. the at least one radioactive isotope is selected from the group consisting of radioactive isotopes having a half-life of more than 10⁵ years;
b. the irradiation flux energy of the target is 0.01 ev-100 kev;
c. harvesting gasses and or transmuted isotopes, contained in the target assembly, for medical or industrial applications.

3. The method of claim 2 further comprising:
a. the particles have generally consistent diameters.

4. The method of claim 3 further comprising:
a. the moderator is selected from the group consisting of yttrium hydride, calcium hydride, beryllium hydride and magnesium hydride;
b. the at least one radioactive isotope is selected from the group consisting of Cadmium-113, Iodine-129, Palladium-107, Technetium-99, Cesium-135, Zirconium-93, Selenium-79 and Tin-126.

5. The method of claim 4 further comprising:
a. reducing isotope and moderator to particles sized in the range of 0.01 mm to 1.0 cm diameter;
b. the irradiation flux energy of the target assembly is 100 ev-20 Mev.

6. The method of claim 5 further comprising:
a. reducing isotope and moderator to particles sized in the range of 0.01 mm to 1.0 mm diameter;
b. mixing the isotope and moderator to a homogeneous mixture.

7. The method of claim 6 further comprising:
a. the target assembly consists of at least one container containing the target.

8. The method of claim 7 further comprising:
a. the at least one container can be vented.

9. The method of claim 8 further comprising:
a. containing gasses within the target assembly;
b. harvesting the gases contained in the target assembly with a reactor gas recovery system.

10. The method of claim 9 further comprising:
a. harvesting transmuted short lived isotopes, if any, for medical or industrial uses;
b. the reactor gas recovery system utilizes a rabbit to periodically retrieve and reinsert the at least one cylinder from and into the reactor.

11. The method of claim 10 further comprising:
a. harvesting the gasses Xe-129, Xe-130 and Xe-132 when the very long lived isotope is I-129;
b. harvesting the transmuted isotope I-131 when the very long lived isotope is I-129;
c. the irradiation flux is in a fast reactor.

12. A Method of Transmutation of Long Lived Isotopes comprising:
a. irradiating a homogeneous mixture of a moderator and at least one very long lived radioactive isotope to transmute the at least one very long lived radioactive isotope to short lived or stable isotopes.

13. The method of claim 12 further comprising:
a. the moderator is from the group of hydrides of yttrium, calcium, beryllium and magnesium.

14. The method of claim 13 further comprising:
a. the irradiation flux energy is 0.01 ev-20 MeV.

15. The method of claim 14 further comprising:
a. selecting the moderator MgH₂ when the at least one radioactive isotope is selected from the group consisting of I-129 and Tc-99;
b. where the isotope is Iodine-129, τ=1.57×10⁷ years or Technetium-99, τ=4.2×10⁶ years, essentially completely “burning out” said isotopes, in a large fast reactor, over a period of approximately 400 days;
c. where the irradiation flux energy is 0.01 ev-100 kev; and
c. transmuting Iodine-129 (I-129) to the major therapeutic medical isotope Iodine-131 (I-131) and or Xenon isotopes 129 or 130 or 131, which have a commercial value, and transmuting Technetium-99 (Tc-99) to the stable “noble” metal Ruthenium-100 (Ru-100).

16. The method of transmutation of long lived radioactive isotopes comprising:
a. selecting at least one very long lived radioactive isotope from the group consisting of isotopes having a half life of at least 10⁵ years;
b. selecting a moderator from the group consisting of hydrides or oxides;
c. mixing particles of the moderator with particles of the isotope forming a target;
d. irradiating the target for transmutation of the at least one very long lived radioactive isotope to a short lived or stable isotope not requiring long term storage.

17. The method of claim 16 further comprising:
a. the at least one very long lived radioactive isotope from the group consisting of Cadmium-113, Iodine-129, Palladium-107, Technetium-99, Cesium-135, Zirconium-93, Selenium-79 and Tin-126;
b. containing the target in a target assembly;
c. the irradiation flux energy of the target assembly is 100 ev-20 Mev; the irradiation flux energy of the target is 0.01 ev-100 kev.

18. The method of claim 17 further comprising:
a. capturing and venting gases, if any, contained in the target assembly.

19. The method of claim 18 further comprising:
a. retrieving the target assembly by use of a rabbit.

20. A Method of Burning Out Long Lived Isotopes comprising:
a. selecting at least one isotope from the group consisting of very long lived isotopes including Iodine-129, τ=1.57×10⁷ years and Technetium-99, τ=4.2×10⁶ years);
b. selecting a moderator from the group consisting of oxides or hydrides;
c. homogeneously mixing the at least one isotope and the moderator; the homogeneous mixture comprising a target; the at least one isotope comprising at least one isotope desired to be transmuted to a stable or short-lived isotope not requiring very long term storage;
d. irradiating the target;
e. containing the target in a target assembly.

21. The method of claim 20 further comprising:
a. irradiating the target with a flux energy of 0.01 ev-20 MeV;
b. the target assembly is capable of being vented;
c. periodically retrieving the target assembly and harvesting gasses and or transmuted isotopes.

22. The method of claim 21 further comprising:
a. irradiating the target assembly with a flux energy of 100 ev-20 MeV;
b. reducing the at least one isotope and moderator to particles sized in the range of 0.01 mm to 1.0 cm diameter.

23. The method of claim 22 further comprising:
a. reducing the at least one isotope and moderator to particles sized in the range of 0.01 mm to 1.0 mm diameter.

24. A method for transmuting spent fuel from a nuclear reactor or from a defense waste stream, said method comprising the steps of:
a. homogeneously combining particles of at least one radioactive component, comprised of radioactive spent fuel and or radioactive defense waste, with particles of a moderator; the homogeneous mixture comprising a target;
b. irradiating the target with a flux thereby transmuting at least a portion of said radioactive component to a short lived or stable isotope not requiring long term storage;
c. separating said the at least one radioactive component into fractions including at least one nontransmuted fraction and at least one transmuted transuranic fraction; reintroducing said at least one nontransmuted fraction into said flux for further transmutation;
d. capturing gasses, if any, which are produced by the process;
e. disposing of the transmuted fraction into storage or for medical or industrial uses;
f. disposing of the captured gasses for medical or industrial uses.

25. The method of claim 24 further comprising:
a. the at least one radioactive component is from the group consisting of very long lived isotopes; the moderator is selected from the group consisting of materials that form hydrides or oxides;
b. the flux energy is in the range of 0.01 ev-100 keV;
c. containing the target in a target assembly;
d. the particles of the at least one radioactive component and the particles of the moderator have diameters in the range of 0.01 mm to 1.0 cm.

26. The method of claim 25 further comprising:
a. where the at least one radioactive component is I-129, producing I-131 from double neutron capture from I-129 burnout where the flux energy is from 1.0×10¹⁴ neutrons per cm² per second to 1.0×10¹⁶ neutrons per cm² per second;
b. the particles of the at least one radioactive component and the particles of the moderator have generally consistent diameters within the range of 0.01 mm to 1.0 mm.

27. The method of claim 26 further comprising:
a. the flux energy is 4.0×10¹⁵ neutrons per square centimeter per second.

28. The method of claim 27 further comprising:
a. the flux is in a fast reactor
b. the particles of the at least one radioactive component and the particles of the moderator have generally consistent diameters in the range of 0.01 mm to 1.0 cm.

29. The method of claim 28 further comprising:
a. the particles of the at least one radioactive component and the particles of the moderator have generally consistent diameters in the range of 0.01 mm to 1.0 mm.
